(19) United States
(12) Patent Application Publication
(10) Pub. No.: US 2026/0270284 A1
(43) Pub. Date: Sep. 10, 2026

(54) RISK ASSESSMENT IN RESOURCE DISTRIBUTION SYSTEMS

(71) Applicant: THE HUNTINGTON NATIONAL BANK, Columbus, OH (US)

(72) Inventors: Timothy Gorman, Columbus, OH (US); Doug Henderson, Columbus, OH (US); Scott M. Gallaway, Columbus, OH (US)

(73) Assignee: THE HUNTINGTON NATIONAL BANK, Columbus, OH (US)

(21) Appl. No.: 19/071,953

(22) Filed: Mar. 6, 2025

Related U.S. Application Data
(63) Continuation of application No. 19/071,860, filed on Mar. 6, 2025.

(51) Int. Cl. H04L 9/40; G06V 30/10

(52) U.S. Cl. CPC H04L 63/1433; G06V 30/10; H04L 63/101

(57) ABSTRACT

A system for restricting access to resources based on detecting a candidate unauthorized recipient and determining a likelihood of risk. For example, the system can receive a file comprising an image of a request to distribute at least one resource from a user to a recipient. The system can extract the name of the recipient from the image. The system can determine a plurality of names of candidate unauthorized recipients based on the user and determine a match between the name of the recipient and a name of the plurality of names of candidate unauthorized recipients. The system may prevent the recipient from accessing the at least one resource and determine a risk score in response to determining the match. The system can control a distribution processing model to provide access to the recipient to the resource in response to determining that the risk score is below a pre-set threshold.

### CROSS-REFERENCE TO RELATED APPLICATION

This is a continuation of U.S. patent application Ser. No. 19/071,860, filed Mar. 6, 2025, and titled “RISK ASSESSMENT IN RESOURCE DISTRIBUTION SYSTEMS,” the entirety of which is incorporated herein by reference.

### TECHNICAL FIELD

The disclosure relates generally to resource distribution. More specifically, but not by way of limitation, this disclosure relates to techniques for risk assessment in resource distribution systems.

### BACKGROUND

Resource distribution systems often distribute resources from users of the resource distribution system to recipients associated with a different resource distribution system. Other resource distribution systems may have more information about the user than information about the recipient. So, fraud prevention techniques in other resource distribution systems typically focus on confirming an authenticity of the user without considering the recipient.

### SUMMARY

According to one example, a system may include a processor and a memory that is communicatively coupled to the processor. The memory includes instructions that configure the processor to perform operations. The operations may include receiving a file comprising an image of a request to distribute at least one resource from a user to a recipient. The operations may also include extracting, using a trained machine learning model, a first name of the recipient from the image. The operations may also include determining a plurality of names of candidate unauthorized recipients based on the user, determining a match between the first name of the recipient and a second name of the plurality of names of candidate unauthorized recipient, and preventing access by the recipient to the at least one resource in response to determining the match. The operations may also include determining a risk score associated with the recipient, using a risk assessment model, based on comparing information extracted from the image with stored information in response to preventing the access, and controlling a distribution processing model to provide the access to the recipient to the at least one resource in response to determining that the risk score is below a pre-set threshold.

According to one example, a method may involve receiving a file comprising an image of a request to distribute at least one resource from a user to a recipient. The method may also involve extracting, using a trained machine learning model, a first name of the recipient from the image. The method may also involve determining a plurality of names of candidate unauthorized recipients based on the user, determining a match between the first name of the recipient and a second name of the plurality of names of candidate unauthorized recipient, and preventing access by the recipient to the at least one resource in response to determining the match. The method may also involve determining a risk score associated with the recipient, using a risk assessment model, based on comparing information extracted from the image with stored information in response to preventing the access, and controlling a distribution processing model to provide the access to the recipient to the at least one resource in response to determining that the risk score is below a pre-set threshold.

In a further example, a non-transitory computer-readable medium includes instructions that are executable by a processor for causing the processor to perform operations. The operations may include receiving a file comprising an image of a request to distribute at least one resource from a user to a recipient. The operations may also include extracting, using a trained machine learning model, a first name of the recipient from the image. The operations may also include determining a plurality of names of candidate unauthorized recipients based on the user, determining a match between the first name of the recipient and a second name of the plurality of names of candidate unauthorized recipient, and preventing access by the recipient to the at least one resource in response to determining the match. The operations may also include determining a risk score associated with the recipient, using a risk assessment model, based on comparing information extracted from the image with stored information in response to preventing the access, and controlling a distribution processing model to provide the access to the recipient to the at least one resource in response to determining that the risk score is below a pre-set threshold.

According to one example, a system may include a processor and a memory that is communicatively coupled to the processor. The memory includes instructions that configure the processor to perform operations. The operations may include receiving a file comprising an image of a request to distribute at least one resource from a user to a recipient, extracting, using a trained machine learning model, a first name of the recipient from the image, and determining a plurality of names of candidate unauthorized recipients based on the user. The operations may also include determining a match between the first name of the recipient and a second name of the plurality of names, extracting, using the trained machine learning model, a geometry object comprising a first signature of the recipient from the image in response to determining the match, and retrieving a plurality of geometry objects corresponding to a plurality of signatures associated with the second name. The operations may also include determining a first risk score based on comparing, using a handwriting analysis tool, the first signature of the recipient with the plurality of signatures, and determining, using a risk assessment model, a second risk score associated with the recipient based on comparing information extracted from the image with stored information in response to determining that the first risk score is below a first pre-set threshold. The operations may also include controlling a distribution processing model to provide access to the recipient to the at least one resource in response to determining that the second risk score is below a second pre-set threshold.

According to another example, a method may involve receiving a file comprising an image of a request to distribute at least one resource from a user to a recipient, extracting, using a trained machine learning model, a first name of the recipient from the image, and determining a plurality of names of candidate unauthorized recipients based on the user. The method may also involve determining a match between the first name of the recipient and a second name of the plurality of names, extracting, using the trained machine learning model, a geometry object comprising a first signature of the recipient from the image in response to determining the match, and retrieving a plurality of geometry objects corresponding to a plurality of signatures associated with the second name. The method may also involve determining a first risk score based on comparing, using a handwriting analysis tool, the first signature of the recipient with the plurality of signatures, and determining, using a risk assessment model, a second risk score associated with the recipient based on comparing information extracted from the image with stored information in response to determining that the first risk score is below a first pre-set threshold. The method may also involve controlling a distribution processing model to provide access to the recipient to the at least one resource in response to determining that the second risk score is below a second pre-set threshold.

In a further example, a non-transitory computer-readable medium includes instructions that are executable by a processor for causing the processor to perform operations. The operations may include receiving a file comprising an image of a request to distribute at least one resource from a user to a recipient, extracting, using a trained machine learning model, a first name of the recipient from the image, and determining a plurality of names of candidate unauthorized recipients based on the user. The operations may also include determining a match between the first name of the recipient and a second name of the plurality of names, extracting, using the trained machine learning model, a geometry object comprising a first signature of the recipient from the image in response to determining the match, and retrieving a plurality of geometry objects corresponding to a plurality of signatures associated with the second name. The operations may also include determining a first risk score based on comparing, using a handwriting analysis tool, the first signature of the recipient with the plurality of signatures, and determining, using a risk assessment model, a second risk score associated with the recipient based on comparing information extracted from the image with stored information in response to determining that the first risk score is below a first pre-set threshold. The operations may also include controlling a distribution processing model to provide access to the recipient to the at least one resource in response to determining that the second risk score is below a second pre-set threshold.

### BRIEF DESCRIPTION OF THE DRAWINGS

FIG. 1 is a block diagram of a system for detecting signs of fraud and controlling access to resources based on detecting signs of fraud according to one aspect of the disclosure.

FIG. 2 illustrates an example of a computing device that may implement the resource distribution system described in FIG. 1, according to one aspect of the disclosure.

FIG. 3 is a block diagram of an example of a model-training application that may be implemented to train a machine-learning model, according to one aspect of the disclosure.

FIG. 4 is a flowchart of controlling access to resources based on determining a risk score in response to determining the recipient is a candidate unauthorized recipient according to one aspect of the disclosure.

FIG. 5 is a flowchart of determining a risk score based on handwriting analysis according to one aspect of the disclosure.

FIG. 6 is a flowchart of determining a risk score based on comparing the quantity of resources from the request to quantities previously distributed according to one aspect of the disclosure.

FIG. 7 is a flowchart of determining a risk score based on temporal information according to one aspect of the disclosure.

FIG. 8 is a flowchart of determining a risk score based on pre-authorized distributions according to one aspect of the disclosure.

FIG. 9 is a flowchart of determining a risk score based on verifying request features according to one aspect of the disclosure.

FIG. 10 is a flowchart of determining a risk score based on terminal information according to one aspect of the disclosure.

### DETAILED DESCRIPTION

Certain aspects and features of the present disclosure relate to a system for controlling a resource distribution system based on determining a risk of fraud. In some examples, the resource distribution system can receive a file including an image of a request and pre-extracted data. The request may be a request to distribute a quantity of resources from a user to a recipient. The resource distribution system can extract a name of the recipient from the image of the request. The resource distribution system can generate a list of candidate unauthorized recipients based on the user. For example, a list of candidate unauthorized recipients may be a list of recipients that have previously tried to fraudulently access resources. The resource distribution system can determine a match between the name of the recipient and a name from the list of candidate unauthorized recipients, indicating that the recipient may be an unauthorized recipient.

The resource distribution system can then determine a risk score representing a likelihood of the recipient being an unauthorized recipient in response to determining a match between the name of the recipient and a name from the list of candidate unauthorized recipients. The resource distribution system can determine the risk score by comparing data extracted from the request with stored data known to be authentic. The resource distribution system can then control access to resources based on the risk score. For example, if the risk score is higher than a pre-set threshold, the resource distribution system can prevent the resources from being distributed to the recipient. Or, if the risk score is lower than the pre-set threshold, the resource distribution system can cause the resources to be distributed to the recipient.

In other resource distribution systems, attempts to mitigate fraud may rarely factor in the recipient. In addition, recipients may often be associated with a different resource distribution system than the user. Accordingly, little information may be available regarding the recipient. Embodiments of the present disclosure use information regarding the recipient as a trigger to instantiate fraud prevention techniques. Instantiating fraud prevention techniques for requests that are more likely to be fraudulent improves security of resource distribution systems while reducing computational load.

The present disclosure can improve the functionality of resource distribution systems by minimizing fraud detection operations through improving a detection rate of fraudulent attempts to access resources. Some resource distribution systems process millions of resource distributions from users to recipients per day. Many of the recipients may present minor risk of fraud. Identifying a match between a recipient and a list of candidate unauthorized recipients allows the resource distribution system to limit computationally expensive fraud verification techniques to a subset of recipients most likely to have submitted a fraudulent request to distribute resources. Limiting computationally expensive fraud detection techniques to a subset of recipients most likely to have submitted a fraudulent request allows the resource distribution system to maintain a high level of security at a fraction of the computational cost of executing the various fraud prevention techniques for every possible recipient.

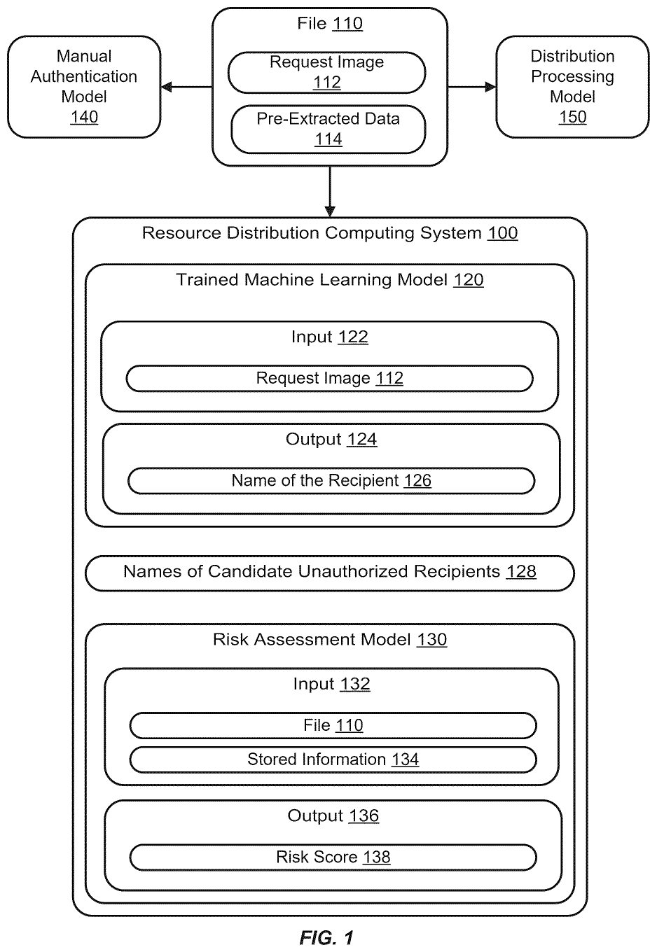

FIG. 1 is a block diagram of a system for detecting signs of fraud and controlling access to resources based on detecting signs of fraud according to one aspect of the disclosure. A resource distribution computing system 100 can receive a file 110. The file 110 can include a request image 112 or pre-extracted data 114. The request image 112 can be a scanned copy of a written instrument directing a distribution of resources from a user to a recipient, such as a check. A user can be an entity, either an individual or an organization, with an account managed by the resource distribution computing system 100. The pre-extracted data 114 can be a name of the user, an account number of the user account number, an account number of the recipient, a routing number of the recipient, a date, a quantity, or terminal information.

The resource distribution computing system 100 can, using a trained machine learning model 120, generate an output 124 of a name of the recipient 126 from an input 122 of the request image 112. The recipient can be an entity designated to receive the resources indicated in the request.

The resource distribution computing system 100 can compare the name of the recipient 126 to names of candidate unauthorized recipients 128. Names of candidate unauthorized recipients 128 can be determined based on the user. Names of candidate unauthorized recipients 128 can include names of recipients who have fraudulently tried to access resources managed by resource distribution computing system 100, names of recipients a user has never distributed resources to, names of famous people, or names of recipients with an address outside a geographical boundary of an address of the user. For example, resource distribution computing system 100 can generate a list of candidate unauthorized recipients by generating a list including names of recipients who have fraudulently tried to access resources, and names of famous people. Resource distribution computing system 100 can then remove names of recipients to whom the user has previously distributed resources to. For example, the name Taylor Swift may be a name of a famous person. But the name Taylor Swift can be removed from the list of candidate unauthorized recipients 128 for a user that frequently distributes resources to a recipient named Taylor Swift. In some embodiments, the resource distribution computing system 100 can remove names that a user has distributed resources to more than a pre-set number of times from candidate unauthorized recipients 128.

In response to determining a match between the name of the recipient 126 and a name of the names of candidate unauthorized recipients 128, the resource distribution computing system 100 can restrict access to the resource. Restricting access to the resource can include generating and sending a signal indicating a command to prevent the request file from entering distribution processing model 150 for a pre-determined time period. As such, the recipient is prevented from accessing the resource. Restricting access to the resource can include sending the file to a manual authentication model 140. The manual authentication model 140 can include human review of file 110. The manual authentication model 140 can prompt a user to verify the authenticity of file 110. For example, a notification may be output at a user interface indicating that verification is needed. The user can then provide a user input indicating whether the recipient is permitted to access the resources,

In response to determining a match between the name of the recipient 126 and a name in the names of candidate unauthorized recipients 128, the resource distribution computing system 100 can determine a risk score 138. The risk score 138 can represent a likelihood that the request is not valid or is associated with a fraudulent recipient. Resource distribution computing system 100 can determine a risk score by comparing information from file 110 to information known to be authentic. The information can include any data appearing on request image 112, such as a name of the recipient, a routing number of the recipient, a quantity, a terminal of the request, a date of the request, a time of the request, a font type, a color saturation, a logo, a signature, an account number of a user, a routing number of a user, etc. The information can be pre-extracted data 114 or information extracted from request image 112. The resource distribution computing system 100 can compare extracted information with stored information 134 using a trained machine learning model 120. The trained machine learning model 120 can receive inputs of the file 110 or stored information 134. Stored information 134 can be information about the date, quantity, recipient, time, or terminal of past distributions from the user. The stored information 134 can include a database of authenticated signatures of the recipient or authenticated signatures of the user. Stored information 134 can include authenticated features of a request image. The trained machine learning model 120 can generate an output 136 of the risk score 138.

The resource distribution computing system 100 can control the distribution processing model 150 to provide access to the recipient to the resource in response to determining that the risk score 138 is below a pre-set threshold (e.g., 0.6). The resource distribution computing system 100 can control the distribution by forwarding the file 110 to the distribution processing model 150 or issuing a command authorizing the distribution processing model 150 to allow the recipient to access the at least one resource. The distribution processing model 150 can be an automated clearing house system that automatically distributes the resource upon receiving the file 110 or the command. Resources can be distributed directly to the recipient. Resources can be distributed to the resource distribution system where the recipient is a user. Resources can be distributed to other resource distribution systems in batches with instructions for the final destination of the resources distribution system. Distributing resources can be done by issuing a command to another resource distribution system to distribute the resources.

In some examples of the present disclosure, a request can be a check. The resource distribution system can receive a file including a scanned image of the check and data previously extracted from the check. The data previously extracted from the check can be a name of the recipient, an account number of the recipient, a routing number of the recipient, a quantity the check is written for, etc. The resource distribution system can also extract the name of a recipient of the check. The resource distribution system can determine a list of candidate unauthorized recipient names based on the user. For example, the list of candidate unauthorized recipient names can include all names that have previously been associated with a fraudulent check and all names to which the recipient has never previously written a check. In response to determining the name of the recipient matches a name in the list of candidate unauthorized recipient names, the resource distribution system can send the file to a risk assessment model and restrict access to the funds. Restricting access to the funds can be halting processing of the payment or sending the file to a manual authentication model. Sending the file to a manual authentication model prevents the recipient from accessing the funds until a human operator verifies the check.

The risk assessment model can determine a risk score by analyzing information from the file for signs of fraud. In some examples, the risk assessment model can determine a risk score by determining an average and standard deviation of all the quantities a recipient has sent. The risk assessment model can determine how many standard deviations the quantity the check is written for is above or below the average quantity. A quantity the check is written for multiple standard deviations above the average quantity can correspond with a high-risk score. A quantity the check is written is at or below the average quantity can correspond with a low-risk score. In response to determining a low-risk score, the resource distribution system can send the file to a distribution processing model. A distribution processing model can send funds through the Automated Clearing House to the recipient bank. The recipient bank can then deposit the funds in the payee account. Accordingly, sending the file to the distribution processing model 150 or commanding the distribution model 150 can control the distribution so that the recipient can access the quantity that the check is written for.

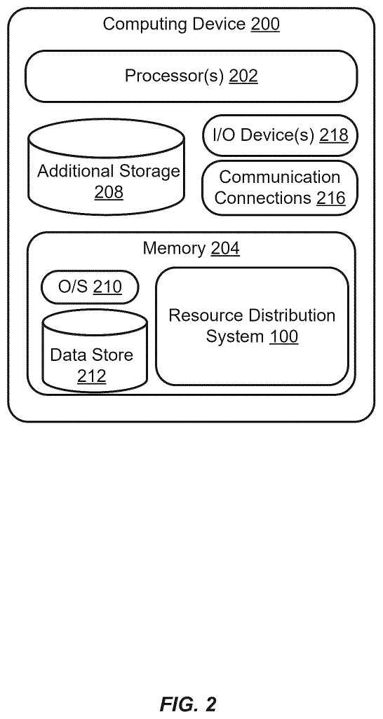

FIG. 2 illustrates an example of a computing device 200 that can implement the resource distribution system described in FIG. 1. Aspects of FIG. 2 are described with respect to the components in FIG. 1.

Computing device 200 can include memory 204. The memory 204 can store computer-executable instructions that are loadable and executable by the processor 202(s) 202, as well as data generated during the execution of these programs. The memory 204 can be volatile (such as RAM) or non-volatile (such as ROM, flash memory, etc.). The computing device 200 can include additional storage 206, which can include removable storage or non-removable storage. The additional storage 206 can include, but is not limited to, magnetic storage, optical disks or tape storage. The disk drives and their associated computer-readable media can provide non-volatile storage of computer-readable instructions, data structures, program engines, and other data for the computing devices. In some implementations, the memory 204 or additional storage 206 can individually, or collectively, include multiple different types of memory, such as SRAM, DRAM, or ROM.

The memory 204 or additional storage 208 can be examples of computer-readable storage media. Computer-readable storage media can include volatile, or non-volatile, removable or non-removable media implemented in any method or technology for storage of information such as computer-readable instructions, data structures, program engines, or other data. In some embodiments, memory 204 and the additional storage 208 are examples of computer storage media. Memory 204 or additional storage 208 can include, but are not limited to, PRAM, SRAM, DRAM, RAM, ROM, EEPROM, flash memory or other memory technology, CD-ROM, DVD, magnetic tape, magnetic disk storage or other magnetic storage devices, or any other medium which can be used to store the desired information, and which can be accessed by the computing device 200. Combinations of any of the above should also be included within the scope of computer-readable media. Computer-readable media can include computer-readable instructions, program engines, or other data transmitted within a data signal, such as a carrier wave, or other transmission. However, as used herein, computer-readable storage media does not include computer-readable communication media.

The memory 204 can include an operating system 210 and one or more data stores 212, or one or more application programs, engines, or services for implementing the features disclosed herein, such as the features provided by the resource distribution computing system 100.

The memory 204 can include instructions for the resource distribution computing system 100 of FIG. 1, which can be executable by the processor 202. By executing the instructions, the processor 202 can receive a file 110. The processor 202 can execute a trained machine learning model 120 to extract a name of the recipient 126 from request image 112. Processor 202 can determine a plurality of names of candidate unauthorized recipients 128. Processor 202 can determine a match between the name of the recipient 126 and a name of the plurality of names of candidate unauthorized recipients 128. Processor 202 can restrict access to the resource in response to determining a match. Processor 202 can determine a risk score 138 by executing instructions for a risk assessment model 130. Processor 202 can allow the recipient to access the resource in response to determining a risk score below a pre-set threshold. Processor 202 can allow the recipient to access the resource by commanding distribution processing model 150 to process the distribution indicated by the request.

Computing device 200 can also contain communications connection(s) 216 that allow computing device 200 to communicate with a stored database, another computing device, a server, user terminals or other devices (e.g., via one or more networks, not depicted). Computing device 200 can also include I/O device(s) 218, such as a keyboard, a mouse, a pen, a voice input device, a touch input device, a display, speakers, a printer, etc.

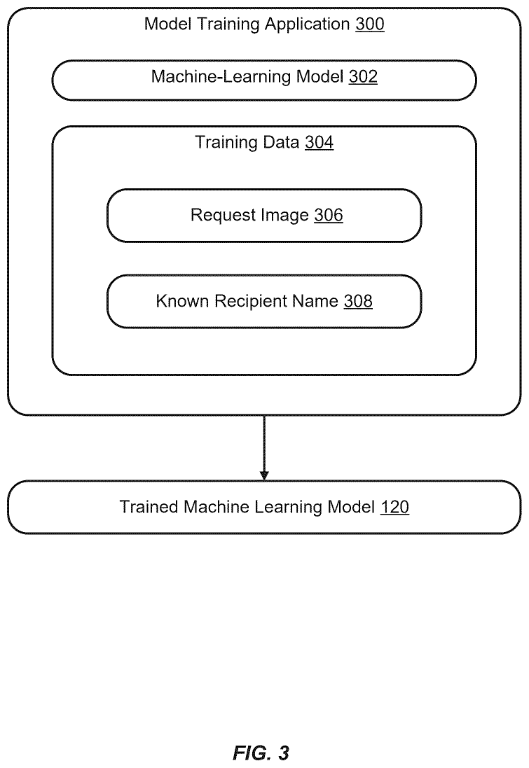

FIG. 3 is a block diagram of an example of a model-training application 300 that can be implemented to train a machine-learning model 302 to generate a trained machine-learning model, such as the trained machine learning model 120 of FIG. 1. The model-training application 300 can be a part of the computing device 200 of FIG. 2, or the model-training application 300 can be separate and remote from the computing device 200 of FIG. 2. Training the machine-learning model 302 can transform the machine-learning model 302 from an untrained state to a trained state (i.e., to a trained machine-learning model).

A “machine learning model” (ML model) may refer to a software engine configured to be run on one or more processors to extract text from an image. The text can comprise a name of the recipient 126, a recipient address, or a date. An ML model can be generated using sample data (e.g., training data) to make predictions on test data. One example is an unsupervised learning model. Another example type of model is supervised learning that can be used with embodiments of the present disclosure. Examples of supervised learning models can include different approaches and algorithms including analytical learning, statistical models, artificial neural network, backpropagation, boosting (meta-algorithm), Bayesian statistics, case-based reasoning, decision tree learning, inductive logic programming, Gaussian process regression, genetic programming, group method of data handling, kernel estimators, learning automata, learning classifier systems, minimum message length (decision trees, decision graphs, etc.), multilinear subspace learning, naive Bayes classifier, maximum entropy classifier, conditional random field, nearest neighbor algorithm, probably approximately correct learning (PAC) learning, ripple down rules, a knowledge acquisition methodology, symbolic machine learning algorithms, subsymbolic machine learning algorithms, minimum complexity machines (MCM), random forests, ensembles of classifiers, ordinal classification, data pre-processing, handling imbalanced datasets, statistical relational learning, or Proaftn, a multicriteria classification algorithm. The model can include linear regression, logistic regression, deep recurrent neural network (e.g., long short term memory, LSTM), hidden Markov model (HMM), linear discriminant analysis (LDA), k-means clustering, density-based spatial clustering of applications with noise (DBSMAY), random forest algorithm, support vector machine (SVM), or any model described herein. Supervised learning models can be trained in various ways using various cost/loss functions that define the error from the known label (e.g., least squares and absolute difference from known classification) and various optimization techniques, e.g., using backpropagation, steepest descent, conjugate gradient, and Newton and quasi-Newton techniques.

Examples of machine learning models include deep learning models, neural networks (e.g., deep learning neural networks), kernel-based regressions, adaptive basis regression or classification, Bayesian methods, ensemble methods, logistic regression and extensions, Gaussian processes, support vector machines (SVMs), a probabilistic model, and a probabilistic graphical model. Embodiments using neural networks can employ using wide and tensorized deep architectures, convolutional layers, dropout, various neural activations, and regularization steps.

Various techniques can be utilized to train the machine-learning model 302. For example, training data 304 can be provided to the machine-learning model 302 in an iterative manner to enable the machine-learning model 302 to identify trends or relationships in the training data 304. The machine-learning model training can be supervised training, unsupervised training, or a semi-supervised training. Parameter or hyperparameter adjustment can also be utilized to minimize a loss function of the machine-learning model 302.

Training the machine-learning model 302 can include accessing the training data 304, which can be stored, for example, at the computing device 200 or at a database or another storage location that is remote from but accessible by the computing device 200. The training data can include a request image 306, tagged with a known recipient name 308. The machine learning model can extract values from the request image 306. The values can be names, addresses, account numbers, quantities, signatures, routing numbers, or memos. Each value that the machine learning model returns can be associated with a corresponding x-y coordinate of where in the request the value was extracted. Rules can be applied to the machine learning model to match a value with a key by comparing x-y coordinates of a first value with x-y coordinates of a second value. For example, a machine learning model can return two names. The machine learning model can be trained to assign an address value with a key of name of the recipient if the machine learning model extracts two name values and the second name value is associated with a higher y coordinate than the first address value.

In some embodiments, the trained machine learning model 120 can employ techniques consistent with optical character recognition (OCR) or intelligent character recognition (ICR) to extract geometry objects. OCR can involve preprocessing the request image 112, which can deskew the image, eliminate any digital image spots, or categorize light areas as background and dark areas as text. OCR can recognize text by pattern matching or by feature extraction. Pattern matching isolates individual characters, called glyphs, and compares the glyphs with stored glyphs. Feature extraction decomposes glyphs into features. Features can be lines, closed loops, line intersections, and line directions. Features can be used to find a best match of a stored glyph with similar features. ICR is similar to OCR but operates on words as opposed to individual characters. Trained machine learning model 120 can process the extracted characters into values and match the values to corresponding stored keys based on the coordinates of the values in the request image 112. For example, the trained machine learning model 120 can determine a coordinate of a geometry object in the image and determine that the coordinate is associated with a recipient signature attribute (e.g., based on the training or a mapping between coordinates and attributes). So, the trained machine learning model 120 can extract the geometry object as a signature of the recipient based on the coordinate being associated with the recipient signature attribute. Trained machine learning model 120 can also capture characters that OCR or ICR do not match as geometry objects.

Various fitting, estimation, or other model-training optimization techniques can be used to ensure that, upon evaluation, the predictive output of the trained machine learning model 120 is accurate given the input data (i.e., to minimize the loss function). The resulting trained machine learning model 120 can then be deployed for application to newly received input data, as described above.

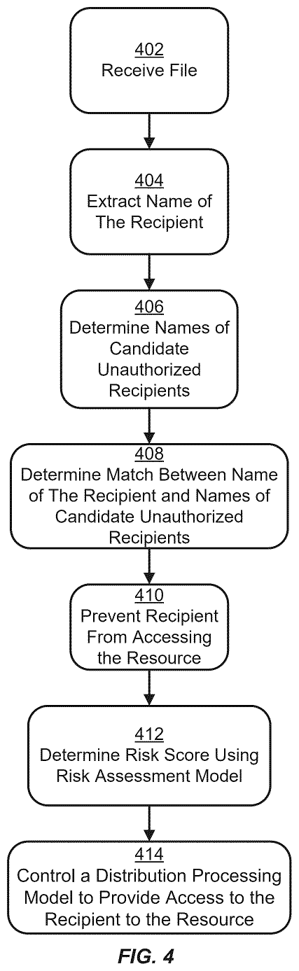

FIG. 4 is a flowchart of controlling access to resources based on determining a risk score in response to determining the recipient is a candidate unauthorized recipient. Aspects of FIG. 4 are described with respect to the components in FIGS. 1-3, but other implementations are possible.

At block 402, processor 202 can receive file 110. File 110 can include a request image 112 or pre-extracted data 114. Request image 112 can be a scanned copy of a written instrument directing a distribution of resources from a user to a recipient, such as a check. A user can be an entity, either an individual or an organization, with an account managed by resource distribution computing system 100.

At block 404, processor 202 can extract the name of the recipient. Extracting the name of the recipient can be done by executing trained machine learning model 120. Trained machine learning model 120 can have input of file 110 and output of a name of the recipient 126. A recipient can be an entity designated to receive the resources indicated in the request image 112.

At block 406, processor 202 can determine a plurality of names of candidate unauthorized recipients. Names of candidate unauthorized recipients 128 can be determined based on the user. Names of candidate unauthorized recipients 128 can be all names not appearing on a list of approved recipients. Approved recipients can be recipients a user has previously transferred resources to in a pre-set time window. Names of candidate unauthorized recipients 128 can include recipients who have previously attempted to fraudulently access resources managed by resource distribution computing system 100.

At block 408, processor 202 can determine match between the name of the recipient and a name of the plurality of names of candidate unauthorized recipients 128. A match can also require a match between both a name and an address of a candidate unauthorized recipient. A match can also include matches between the name of the recipient and common misspellings of the names of candidate unauthorized recipients 128.

At block 410, processor 202 can prevent access to the resource. Processor 202 can restrict access to the resource by removing file 110 from distribution processing model 150. Processor can automatically return the file 110 to distribution processing model 150 after a pre-set time if file 110 is not sent to manual authentication model 140. Processor 202 can restrict access to the resource by sending the file to manual authentication model 140.

At block 412, processor 202 can determine a risk score 138 using a risk assessment model 130. Risk assessment model 130 can use a trained machine learning model to determine the risk score 138. Risk assessment model 130 can also perform statistical analysis. For example, risk assessment model 130 can determine an average and a standard deviation of quantities of resources distributed from the user. Processor 202 can determine risk score 138 based on how many standard deviations above average the quantity of the request is.

At block 414, processor 202 can control a distribution processing model 150 to provide the access to the recipient to the resource in response to determining that the risk score 138 is below a pre-set threshold. Processor 202 can allow the recipient to access the resource by sending the file 110 to the distribution processing model 150 or by commanding the distribution processing model 150 to process the request. The distribution processing model 150 can batch process files. The distribution processing model 150 can be an ACH payment model. If the risk score 138 is above the pre-set threshold, processor 202 can control the distribution by preventing access by the recipient to the at least one resource.

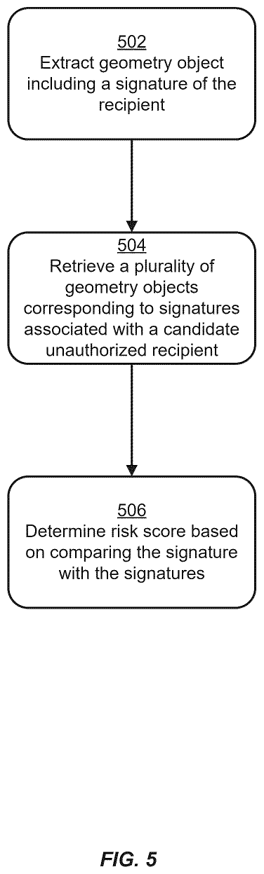

FIG. 5 is a flowchart of determining a risk score based on handwriting analysis. Aspects of FIG. 5 are described with respect to the components in FIG. 1-2, but other implementations are possible. The steps of FIG. 5 can occur between block 410 and block 412 of FIG. 4. So, the risk score determined using a risk assessment model as shown in block 412 may be a second risk score.

At block 502, a processor 202 can extract a geometry object, including a signature of the recipient. The geometry object can be extracted from request image 112. A signature of the recipient can be determined based on a coordinate of the geometry object in the request image 112. For example, the signature may correspond to a geometry object that is in a predetermined location in the request image 112.

At block 504, the processor 202 can retrieve a plurality of geometry objects corresponding to signatures associated with a candidate unauthorized user. The candidate unauthorized user can be the candidate authorized user having a name that is determined to match the name of the recipient in block 408 of FIG. 4. The signatures can include authenticated signatures associated with the recipient and can be compiled from prior requests to distribute resources from the user to the recipient or prior requests to distribute resources to the user from the recipient.

At block 506, the processor 202 can determine a risk score based on comparing the signature of the recipient to the plurality of signatures. The processor 202 can use a handwriting analysis tool (HAT) to determine the risk score. A high-risk score indicates a high chance that the request is fraudulent. A low-risk score indicates a low chance that the request is fraudulent. A HAT can be a trained machine learning model. A HAT can be trained to compare features of a signature with features of authenticated signatures. Features can include a direction of a line, an angle between lines, a radius of curvature of a line, etc. If the processor 202 determines that the risk score is below a pre-set threshold, the processor 202 can proceed to block 412 to determine a second risk score using a risk assessment model. In some examples, the processor 202 may identify a geometry object in the request image 112 that corresponds to a signature of the user and determine the second risk score by comparing the signature of the user to geometry objects corresponding to authenticated signatures of the user. The processor 202 can then control access to the resource based on the second risk score as described in block 414. If the processor 202 determines that the risk score is above the pre-set threshold, the processor 202 can prevent the recipient from accessing the resource and forgo determining the second risk score.

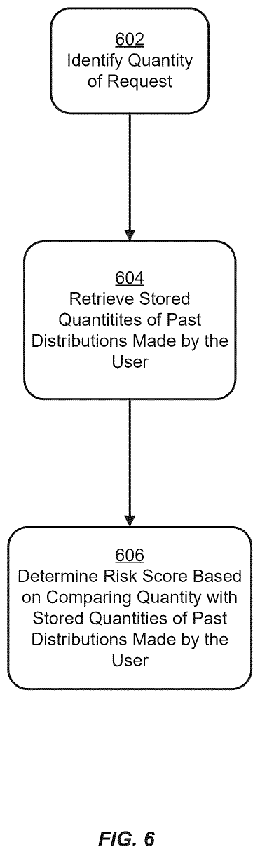

FIG. 6 is a flowchart of determining a risk score based on comparing the quantity of resources from the request to quantities previously distributed. Aspects of FIG. 6 are described with respect to the components in FIGS. 1-2, but other implementations are possible. FIG. 6 represents an embodiment of determining a risk score using a risk assessment model as shown in block 412.

At block 602, a processor (e.g., the processor 202 in FIG. 2) can identify a quantity requested in request image 112. A quantity requested can be identified by extracting the quantity of resources requested from request image 112 using a trained machine learning model, such as trained machine learning model 120. A quantity requested can be identified from pre-extracted data 114.

At block 604, the processor 202 can retrieve stored quantities of past distributions made by the user. Past distributions made by the user can be stored in memory 204 or at a database separate from computing device 200. Past distributions made by the user can be limited to distributions to a specific recipient, distributions to recipients in a particular geographic area, distributions in a pre-set time window, or a combination.

At block 606, processor 202 can determine the risk score based on comparing the quantity requested with quantities of past distributions made by the user. For example, risk assessment model 130 can determine an average and a standard deviation of quantities of resources distributed from the user. Processor 202 can determine risk score 138 based on how many standard deviations above average the quantity of the request is. For example, the pre-set threshold can be 0.5 and the processor 202 can determine that, in past distributions, the user distributed 10, 20, 30, 40, 50, 60, and 70 units of resources. Processor 202 can determine the average quantity of past distributions is 40 units and the standard deviation is 20 units. Processor 202 can determine that a requested quantity of 100 units is 3 standard deviations above the average quantity. A risk score can be the percentage of samples within the number of standard deviations from the mean. In a normal distribution, 99.7% of samples are within three standard deviations from the mean, so the risk score can be 0.997. The processor 202 can prevent the access by the recipient to the at least one resource in response to determining that the risk score of 0.997 is higher than the pre-set threshold of 0.5.

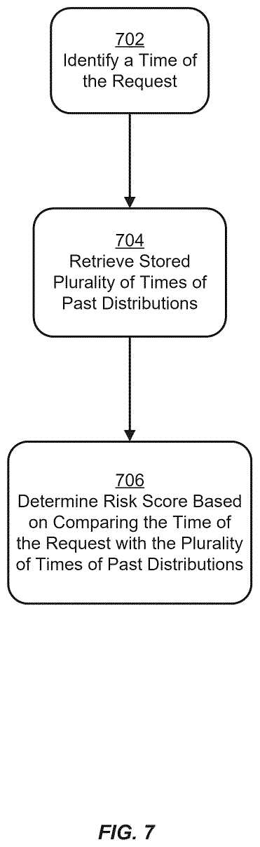

FIG. 7 is a flowchart of determining a risk score based on temporal information. Aspects of FIG. 7 are described with respect to the components in FIGS. 1-2, but other implementations are possible. FIG. 7 represents an embodiment of determining a risk score using a risk assessment model as shown in block 412.

At block 702, processor 202 can identify a time of the request. A time of the request can be identified by extracting the time of the request from request image 112 using a trained machine learning model, such as trained machine learning model 120. A time of the request can be identified from pre-extracted data 114.

At block 704, processor 202 can retrieve a stored plurality of times of past distributions. The plurality of times of past distributions can be stored in memory 204. The plurality of times of past distributions can be limited to distributions to a specific user, distributions to users in a particular geographic area, distributions in a pre-set time window, or a combination.

At block 706, processor 202 can determine the risk score based on comparing the time of the request with the plurality of times of past distributions. A higher risk score can be determined when the time of request is inconsistent with the plurality of times of past distributions. For example, if all past distributions from a user to a recipient have occurred on a Friday afternoon, a time of the request of Monday morning may have a higher risk score than a time of the request of Friday morning. Processor 202 can control access to the at least one resource based on the risk score as described in block 414.

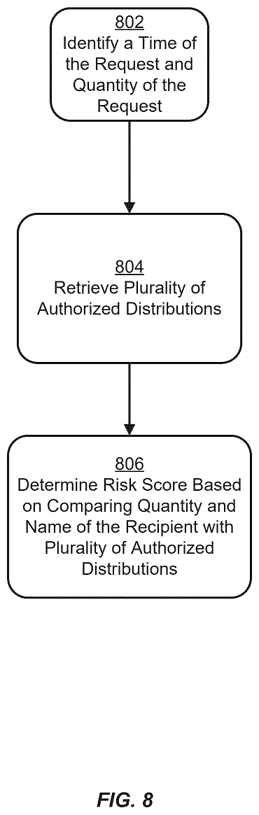

FIG. 8 is a flowchart of determining a risk score based on pre-authorized distributions. Aspects of FIG. 8 are described with respect to the components in FIGS. 1-2, but other implementations are possible. FIG. 8 represents an embodiment of determining a risk score using a risk assessment model as shown in block 412.

At block 802, processor 202 can identify a time of the request and a quantity of the request. The processor 202 can identify a time of the request in the manner described in block 702. Processor 202 can identify a quantity of the request in the manner described in block 602.

At block 804, processor 202 can retrieve a plurality of authorized distributions. The plurality of authorized distributions can be stored in memory 204. The plurality of authorized distributions can be retrieved from a database external to computing device 200. The plurality of authorized distributions can be retrieved from the user or an accounting system associated with the user.

At block 806, processor 202 can determine risk score based on comparing the name of the recipient, the quantity, or the time to the plurality of authorized distributions. A risk score determined in block 806 can be a binary risk score. A risk score of 0 can indicate a match was found and a risk score of 1 can indicate no match was found. Processor 202 can allow access by the recipient in response to determining that the risk score is 0. Alternatively, the processor 202 can prevent access by the recipient to the at least one resource in response to determining a risk score of 1.

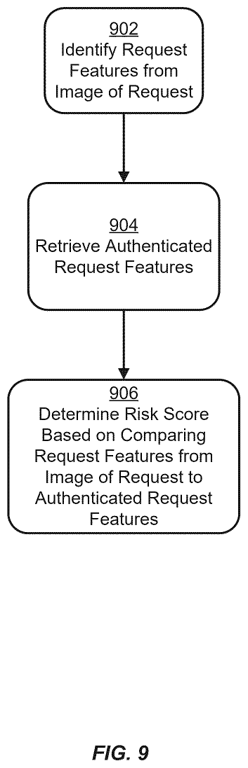

FIG. 9 is a flowchart of determining a risk score based on verifying request features. Aspects of FIG. 9 are described with respect to the components in FIGS. 1-2, but other implementations are possible. FIG. 9 represents an embodiment of determining a risk score using a risk assessment model as shown in block 412.

At block 902, processor 202 can identify request features from request image 112. Request features can be geometry objects on request image 112. Request features can be logos, font size, font type, spacing between glyphs, colors, etc.

At block 904, processor 202 can retrieve authenticated request features. Authenticated request features can be stored in memory 204. Authenticated request features can be request features identified from original requests provided to the user by resource distribution computing system 100. Original requests can be checks issued by a bank.

At block 906, processor 202 can determine the risk score based on comparing request features from the request image to authenticated request features. Processor 202 can determine the risk score using a trained machine learning model. The trained machine learning model can be trained to discount differences in color due to natural fading of ink over time. Processor 202 can control access to the at least one resource based on the risk score as described in block 414.

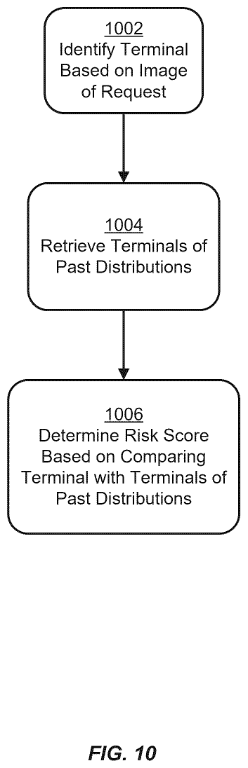

FIG. 10 is a flowchart of determining a risk score based on terminal information. FIG. 10 represents an embodiment of determining a risk score using a risk assessment model as shown in block 412. Aspects of FIG. 10 are described with respect to the components in FIGS. 1-2, but other implementations are possible. FIG. 10 represents an embodiment of determining a risk score using a risk assessment model as shown in block 412.

At block 1002, processor 202 can identify a terminal based on the request image 112.

At block 1004, processor 202 can retrieve a plurality of terminals of past distributions from the user. The plurality of terminals of past distributions from the user can be stored in memory 204. A terminal can indicate a geographic location where the recipient requested to access the resources or a manner in which the recipient requested to access the resources. For example, a terminal can indicate which city a recipient deposited a check in, which branch a recipient deposited a check in, whether the recipient used mobile deposit, or whether the recipient used a lockbox.

At block 1006, processor 202 can determine the risk score based on comparing the terminal to the plurality of terminals of past distributions. Processor 202 can determine the risk score using a trained machine learning model. The trained machine learning model can assign higher risk scores to terminals the recipient has not used before, terminals outside of a geographic area from the address of the recipient, or terminals outside a geographic area of previous terminals. Processor 202 can control access to the at least one resource based on the risk score as described in block 414.

While FIGS. 5-10 describe various embodiments of determining a risk score, one of ordinary skill in the art will recognize that these features can be implemented in a plurality of configurations. Embodiments of determining a risk score can be completed in sequence. For example, the risk assessment model can determine a first risk score through handwriting analysis. In response to determining a first risk score above the pre-set threshold, risk assessment model can determine a second risk score by comparing the quantity to stored quantities of past distributions. Embodiments of determining a risk score can also be completed in parallel. When risk assessment model determines multiple risk scores, risk assessment model can return an average risk score, a weighted average risk score, a low-risk score, or a high-risk score. Embodiments of determining a risk score can be completed in conjunction. For example, a quantity can be compared to a subset of quantities of previously distributed resources in the same geographic region of the request.

The various embodiments further can be implemented in a wide variety of operating environments, which in some cases can include one or more user computers, computing devices or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and other devices capable of communicating via a network.

Most embodiments utilize at least one network that would be familiar to those skilled in the art for supporting communications using any of a variety of commercially-available protocols, such as Transmission Control Protocol/Internet Protocol (“TCP/IP”), Open System Interconnection (“OSI”), File Transfer Protocol (“FTP”), Universal Plug and Play (“UpnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

Storage media computer readable media for containing code, or portions of code, can include any appropriate media known or used in the art, including storage media and communication media, such as but not limited to volatile and non-volatile, removable and non-removable media implemented in any method or technology for storage or transmission of information such as computer readable instructions, data structures, program engines, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device.

The specification and drawings are, accordingly, to be regarded in an illustrative rather than a restrictive sense. Various modifications and changes can be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions, and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

Certain embodiments of this disclosure are described herein, including the best mode known to the inventors for carrying out the disclosure. Variations of those preferred embodiments may become apparent to those of ordinary skill in the art upon reading the foregoing description.

That which is claimed is:

1. A system comprising:
a processor; and
a memory communicatively coupled to the processor, the memory including instructions that configure the processor to perform operations comprising:
receiving a file comprising an image of a request to distribute at least one resource from a user to a recipient;
extracting, using a trained machine learning model, a first name of the recipient from the image;
determining a plurality of names of candidate unauthorized recipients based on the user;
determining a match between the first name of the recipient and a second name of the plurality of names;
extracting, using the trained machine learning model, a geometry object comprising a first signature of the recipient from the image in response to determining the match;
retrieving a plurality of geometry objects corresponding to a plurality of signatures associated with the second name;
determining a first risk score based on comparing, using a handwriting analysis tool, the first signature of the recipient with the plurality of signatures;
determining, using a risk assessment model, a second risk score associated with the recipient based on comparing information extracted from the image with stored information in response to determining that the first risk score is below a first pre-set threshold; and
controlling a distribution processing model to provide access to the recipient to the at least one resource in response to determining that the second risk score is below a second pre-set threshold.

2. The system of claim 1, wherein the memory further includes instructions that configure the processor to perform operations further comprising:
identifying a second geometry object comprising a third signature of the user from the image;
retrieving, from the stored information, a second plurality of geometry objects corresponding to a plurality of authenticated signatures of the user; and
determining the second risk score based on comparing the third signature of the user with the plurality of authenticated signatures.

3. The system of claim 1, wherein the memory further includes instructions that configure the processor to perform operations further comprising:
identifying a quantity of the at least one resource in the request;
retrieving, from the stored information, a plurality of quantities of resources distributed from the user; and
determining the second risk score based on comparing the quantity of the at least one resource to the plurality of quantities of resources distributed from the user.

4. The system of claim 1, wherein the memory further includes instructions that configure the processor to perform operations further comprising:
identifying a time of the request;
retrieving, from the stored information, a plurality of times of past distributions by the user; and
determining the second risk score based on comparing the time of the request and the plurality of times of past distributions.

5. The system of claim 1, wherein the operation of extracting the geometry object comprises:
determining a coordinate of the geometry object in the image;
determining that the coordinate is associated with a recipient signature attribute; and
extracting the geometry object as the first signature of the recipient in response to determining that the coordinate is associated with the recipient signature attribute.

6. The system of claim 1, wherein the memory further includes instructions that configure the processor to perform operations further comprising, in response to determining that the first risk score is above the first pre-set threshold:
preventing the recipient from accessing the at least one resource; and
forgoing determining the second risk score.

7. The system of claim 1, wherein the plurality of geometry objects further correspond to a plurality of authenticated signatures associated with the recipient, and wherein the first risk score is further based on the plurality of authenticated signatures.

8. A method comprising:
receiving a file comprising an image of a request to distribute at least one resource from a user to a recipient;
extracting, using a trained machine learning model, a first name of the recipient from the image;
determining a plurality of names of candidate unauthorized recipients based on the user;
determining a match between the first name of the recipient and a second name of the plurality of names;
extracting, using the trained machine learning model, a geometry object comprising a first signature of the recipient from the image in response to determining the match;
retrieving a plurality of geometry objects corresponding to a plurality of signatures associated with the second name;
determining a first risk score based on comparing, using a handwriting analysis tool, the first signature of the recipient with the plurality of signatures;
determining, using a risk assessment model, a second risk score associated with the recipient based on comparing information extracted from the image with stored information in response to determining that the first risk score is below a first pre-set threshold; and
controlling a distribution processing model to provide access to the recipient to the at least one resource in response to determining that the second risk score is below a second pre-set threshold.

9. The method of claim 8, further comprising:
identifying a second geometry object comprising a third signature of the user from the image;
retrieving, from the stored information, a second plurality of geometry objects corresponding to a plurality of authenticated signatures of the user; and
determining the second risk score based on comparing the third signature of the user with the plurality of authenticated signatures.

10. The method of claim 8, further comprising:
identifying a quantity of the at least one resource in the request;
retrieving, from the stored information, a plurality of quantities of resources distributed from the user; and
determining the second risk score based on comparing the quantity of the at least one resource to the plurality of quantities of resources distributed from the user.

11. The method of claim 8, further comprising:
identifying a time of the request;
retrieving, from the stored information, a plurality of times of past distributions by the user; and
determining the second risk score based on comparing the time of the request and the plurality of times of past distributions.

12. The method of claim 8, wherein extracting the geometry object comprising:
determining a coordinate of the geometry object in the image;
determining that the coordinate is associated with a recipient signature attribute; and
extracting the geometry object as the first signature of the recipient in response to determining that the coordinate is associated with the recipient signature attribute.

13. The method of claim 8, further comprising, in response to determining that the first risk score is above the first pre-set threshold:
preventing the recipient from accessing the at least one resource; and
forgoing determining the second risk score.

14. The method of claim 8, wherein the plurality of geometry objects further correspond to a plurality of authenticated signatures associated with the recipient, and wherein the first risk score is further based on the plurality of authenticated signatures.

15. A non-transitory computer-readable medium comprising instructions that are executable by a processor for causing the processor to perform operations comprising:
receiving a file comprising an image of a request to distribute at least one resource from a user to a recipient;
extracting, using a trained machine learning model, a first name of the recipient from the image;
determining a plurality of names of candidate unauthorized recipients based on the user;
determining a match between the first name of the recipient and a second name of the plurality of names;
extracting, using the trained machine learning model, a geometry object comprising a first signature of the recipient from the image in response to determining the match;
retrieving a plurality of geometry objects corresponding to a plurality of signatures associated with the second name;
determining a first risk score based on comparing, using a handwriting analysis tool, the first signature of the recipient with the plurality of signatures;
determining, using a risk assessment model, a second risk score associated with the recipient based on comparing information extracted from the image with stored information in response to determining that the first risk score is below a first pre-set threshold; and
controlling a distribution processing model to provide access to the recipient to the at least one resource in response to determining that the second risk score is below a second pre-set threshold.

16. The non-transitory computer-readable medium of claim 15, further comprising instructions that cause the processor to perform operations comprising:
identifying a second geometry object comprising a third signature of the user from the image;
retrieving, from the stored information, a second plurality of geometry objects corresponding to a plurality of authenticated signatures of the user; and
determining the second risk score based on comparing the third signature of the user with the plurality of authenticated signatures.

17. The non-transitory computer-readable medium of claim 15, further comprising instructions that cause the processor to perform operations comprising:
identifying a quantity of the at least one resource in the request;
retrieving, from the stored information, a plurality of quantities of resources distributed from the user; and
determining the second risk score based on comparing the quantity of the at least one resource to the plurality of quantities of resources distributed from the user.

18. The non-transitory computer-readable medium of claim 15, further comprising instructions that cause the processor to perform operations comprising:
identifying a time of the request;
retrieving, from the stored information, a plurality of times of past distributions by the user; and
determining the second risk score based on comparing the time of the request and the plurality of times of past distributions.

19. The non-transitory computer-readable medium of claim 15, wherein the operation of extracting the geometry object comprises:
determining a coordinate of the geometry object in the image;
determining that the coordinate is associated with a recipient signature attribute; and
extracting the geometry object as the first signature of the recipient in response to determining that the coordinate is associated with the recipient signature attribute.

20. The non-transitory computer-readable medium of claim 15, further comprising instructions that cause the processor to perform operations comprising, in response to determining that the first risk score is above the first pre-set threshold:
preventing the recipient from accessing the at least one resource; and
forgoing determining the second risk score.
